(19) United States
(12) Patent Application Publication
(10) Pub. No.: US 2019/0372072 A1
(43) Pub. Date: Dec. 5, 2019

(54) ENCAPSULATED MICROBATTERY WITH IMPROVED LEAK TIGHTNESS AND ENCAPSULATION METHOD PROVIDING IMPROVED LEAK TIGHTNESS

(71) Applicant: COMMISSARIAT A L'ENERGIE ATOMIQUE ET AUX ENERGIES ALTERNATIVES, Paris (FR)

(72) Inventors: Messaoud BEDJAOUI, Grenoble Cedex (FR); Jean BRUN, Grenoble Cedex (FR); David SIONNEAU, Chambray-Les-Tours (FR)

(73) Assignee: COMMISSARIAT A L'ENERGIE ATOMIQUE ET AUX ENERGIES ALTERNATIVES, Paris (FR)

(21) Appl. No.: 16/423,870

(22) Filed: May 28, 2019

(30) Foreign Application Priority Data
May 29, 2018 (FR) 18 54577

(51) Int. Cl. H01M 2/12; H01M 10/0525; H01M 4/131

(52) U.S. Cl. CPC H01M 2/1264; H01M 2004/028; H01M 4/131; H01M 10/0525

(57) ABSTRACT

Encapsulated microbattery comprising a microbattery supported by a substrate, an encapsulation cover which comprises a first face in contact with the microbattery and the substrate, said first face comprising a central zone and a peripheral zone surrounding the central zone, the central zone being in contact with the microbattery and the peripheral zone being in contact with at least the substrate. The encapsulation cover comprises cavities in fluid communication with the central zone of the first face, the cavities being configured to collect at least one gaseous element generated by the microbattery during its operation.

### TECHNICAL DOMAIN AND STATE OF PRIOR ART

This invention relates to an encapsulated microbattery with improved leak tightness, for example an encapsulated lithiated microbattery, and an encapsulation method providing improved leak tightness.

Microbatteries, particularly microbatteries based on lithiated materials, are very sensitive to atmospheric elements such as oxygen, nitrogen and water vapour. Encapsulation is made in order to protect the microbatteries and provide long term mechanical and electrical integrity.

For example the microbattery, i.e. the positive electrode, electrolyte, negative electrode stack, is formed by deposition and etching on a substrate and an encapsulation cover is placed on the stack, isolating the stack from the external environment.

In general, there are two types of encapsulation, namely monolithic encapsulation and heterogeneous encapsulation. Monolithic encapsulation is obtained by deposition of layers directly on the substrate and the stack. This type of encapsulation requires an alternation of different natures of layers (organic and inorganic) so as to achieve the required leak tightness performances. The method of making such an encapsulation comprises complex steps and its cost price is high.

Heterogeneous encapsulation consists of transferring a leak tight cover onto the substrate supporting the stack. This type of encapsulation is relatively easy to implement.

The choice of materials forming the positive electrodes is dictated principally by the electrochemical performances necessary for correct operation of the target application. Metal oxides of the LiₓM_{y}O_{z} type (where M is a transition metal such as Fe, Mn, Co, Ni, Ta, Nb, etc.) with for example x≤1, y≤2, and z≤4 to make cathode layers are adapted to applications requiring energies per unit area equal to more than 50 μAh·cm⁻²·μm⁻¹. These positive electrode materials have the advantage that they contain lithium, thus making it possible to use a material not containing lithium to make the negative electrode. This advantage is particularly useful for microbatteries that have to be connected by remelt solder and for which “solder reflow” will be made.

Lithium cobalt oxide (LiCoO₂) is one of the materials most frequently used in the design of positive electrodes for solid microbatteries in thin layers with a capacity of about 62 μAh·cm⁻²·μm⁻¹ and a relatively high nominal operating voltage, for example up to 4.2 V. However, the use of this type of cathode imposes additional constraints on encapsulation systems. The LiCoO₂ layer releases several gaseous elements such as oxygen, hydrogen, carbon oxide, that abundantly accompany electrochemical operation of the electrodes separated by the electrolyte during charge/discharge cycles. Generation of this gaseous flow can cause mechanical deformation of the barrier layers causing degradation to the encapsulation and/or the appearance of bubbles on the surface of the encapsulation system.

### PRESENTATION OF THE INVENTION

Consequently, one purpose of this invention is to disclose an encapsulated microbattery providing leak tightness with better long term properties, and an encapsulation method capable of providing a long lasting encapsulation solution for systems releasing gaseous species throughout their life, for example microbatteries using LiₓM_{y}O_{z} type metal oxides, where M is a transition metal.

The above mentioned purpose is achieved by a lithium microbattery on a support substrate, covered by an encapsulation cover, said cover and/or microbattery and/or the substrate comprising at least one cavity and configured to store gaseous species generated by the microbattery.

Encapsulation can be obtained by means of an encapsulation method including making a cover provided with at least one zone for storage of gaseous species released by the encapsulated system. Thus, the released gases do not apply any stress on the cover, particularly at the peripheral zone of the cover, which could cause degradation of the encapsulation.

For example, the cover comprises a layer that will attach the cover on the device, for example an adhesive. Advantageously, the cavities are formed in this layer.

In one advantageous example, elements are provided in the cavities or in the walls of cavities capable of capturing released gaseous elements, for example getter materials.

The cover can be elastic and deform under pressure of the gas generated.

In other words, the cover and/or the microbattery and/or the substrate are structured before the cover is assembled on the microbattery, such that storage zones are formed capable of containing the released gaseous species throughout the life of the microbattery.

Very advantageously, at least one cavity is formed in the cover set back from the front face of the cover in contact with the microbattery, and at least one channel with a smaller section that those of the cavity opening up in said face allowing gaseous species to flow towards the cavity. Thus, the impact of making the cavity on the bonding surface is reduced, and bonding properties are only slightly modified or are not modified at all by the presence of the at least one cavity.

The application describes then an encapsulated microbattery comprising a microbattery supported on a substrate, an encapsulation cover, said encapsulation cover comprising a first face in contact with the microbattery and the substrate, said first face comprising a central zone and a peripheral zone surrounding the central zone, the central zone being in contact with the device and the peripheral zone being in contact with at least the substrate. The encapsulation cover comprises at least one cavity in fluid communication with the central zone of the first face and/or the substrate and/or the microbattery comprise(s) at least one cavity capable of collecting at least one gaseous element generated by said microbattery.

The application also describes a method of manufacturing at least one encapsulated microbattery comprising:
supply of a microbattery formed on a substrate,
manufacturing of an encapsulation cover comprising a first face provided with a securing layer configured to secure said cover to said microbattery and to said substrate,

the cover comprising at least one cavity in fluid communication with the first face of the cover and/or the microbattery and/or the substrate comprising at least one cavity configured to collect at least one gaseous element generated by the microbatterry.
placement of the cover on the microbattery and on the substrate, such that the first face is in contact with the microbattery and the substrate, and in the case in which the cover comprises a cavity, such that said at least one cavity opens up facing said microbattery,
securing said cover to said microbattery and to said substrate so as to form an encapsulation of said microbattery.

### BRIEF DESCRIPTION OF THE DRAWINGS

This invention will be better understood after reading the following description and the appended drawings on which:

FIG. 1 is a top view of a set of microbatteries on a support substrate before encapsulation,

FIG. 2 is a sectional view of a microbattery in FIG. 1 along plane A-A,

FIG. 3 is a sectional view of an example of a set of encapsulation covers during manufacture,

FIG. 4A is a sectional view of an example of the set of encapsulation covers according to the invention in FIG. 3 ready to be applied onto the microbatteries for their encapsulation,

FIG. 4B is a bottom view of a cover formed from the set of covers in FIG. 4A for the encapsulation of a microbattery,

FIG. 5 is a top view of the set of covers in FIG. 1 encapsulated using the process according to the invention,

FIG. 6 is a sectional view along plane C-C in FIG. 5,

FIG. 7 is a top view of different gas storage cavities according to the invention,

FIG. 8 is a sectional view of an encapsulated microbattery according to one variant of this invention,

FIG. 9 is a top view of another example of a cavity according to the invention,

FIG. 10 is a sectional view of a set of covers according to another embodiment of the invention,

FIG. 11 is a sectional view of an encapsulated microbattery according to another embodiment.

### DETAILED PRESENTATION OF PARTICULAR EMBODIMENTS

The following description applies mainly to the encapsulation of microbatteries for which the positive electrode is LiCoO₂, but it will be understood that this invention is applicable to the encapsulation of any microbattery that might release gaseous species throughout its life, for example during operation.

In this application, “microbattery” refers to a positive electrode, electrolyte, negative electrode stack and electrical contacts, and “encapsulated microbattery” refers to the microbattery formed on a substrate and covered by an encapsulation cover.

In this application, “encapsulation” refers to the fact of isolating a microbattery from the external environment in a sealed manner, particularly from species that could damage the microbattery, for example oxidising it.

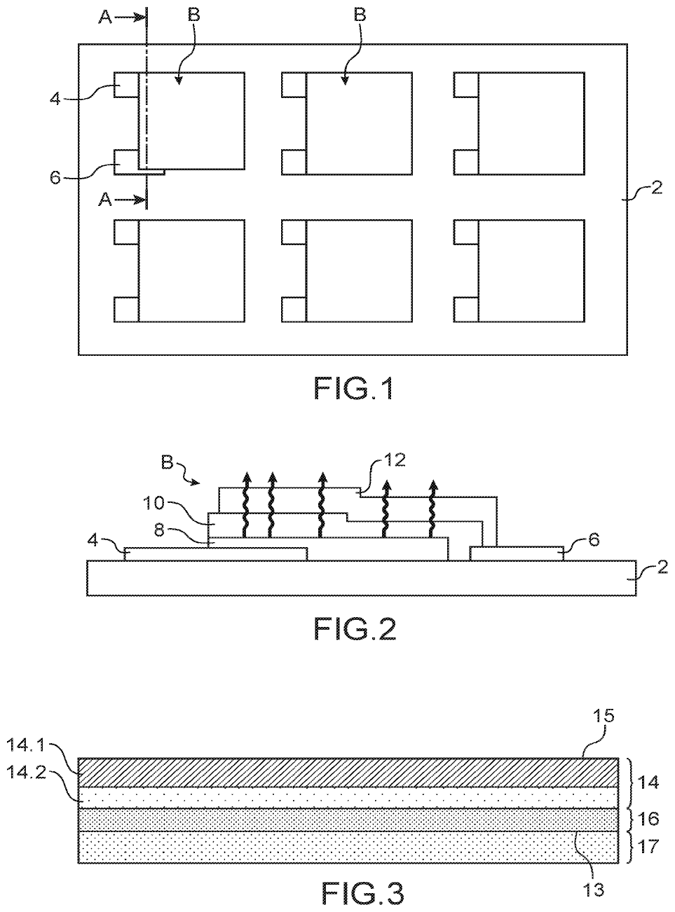

FIG. 1 shows a top view of a system comprising several microbatteries B on a support substrate 2. Throughout the remainder of the description, the invention will be described with reference to a single microbattery, for reasons of simplicity.

For example, the support substrate is made of glass or silicon, and in the latter case the active layers are configured to prevent short circuits.

Each microbattery B comprises a stack represented on FIG. 2 comprising, starting from the support substrate 2, a cathodic current collector 4 and an anodic current collector 6 formed on the substrate 2. The current collectors 4 and 6 are for example made of metal such as titanium, gold, aluminium, platinum, tungsten or another metal or alloy frequently used as current collector.

The stack then comprises the positive electrode or cathode 8, the electrolyte 10 and the negative electrode or anode 12. The positive electrode 8 is in contact with the current collector 4 and the negative electrode 12 is in contact with the current collector 6.

In the example described, the positive electrode is made of LiCoO₂ that has good electronic and ionic conductivity. The electrolyte 10 is an electronic insulator with high ionic conductivity, for example made of LiPON, LiPONB, LiSiCON, etc. The negative electrode 12 may for example be made of metallic lithium, for example obtained by evaporation. As a variant, the negative electrode is a lithiated material, that may be lithiated at the time of the deposit by making a deposit from a lithiated target, or may become a lithiated material during operation of the battery, in this case during fabrication the negative electrode 12 comprises for example a layer of silicon or germanium.

During operation of the battery, LiCoO₂ in the positive electrode releases oxygen, hydrogen and carbon oxide. Preferably, the electrode that releases gaseous elements, in this case the positive electrode, is formed on the support substrate 2 such that the flow of gaseous elements takes place principally through the stack, the support substrate 2 generally being sealed to the gaseous elements because it forms part of the encapsulation.

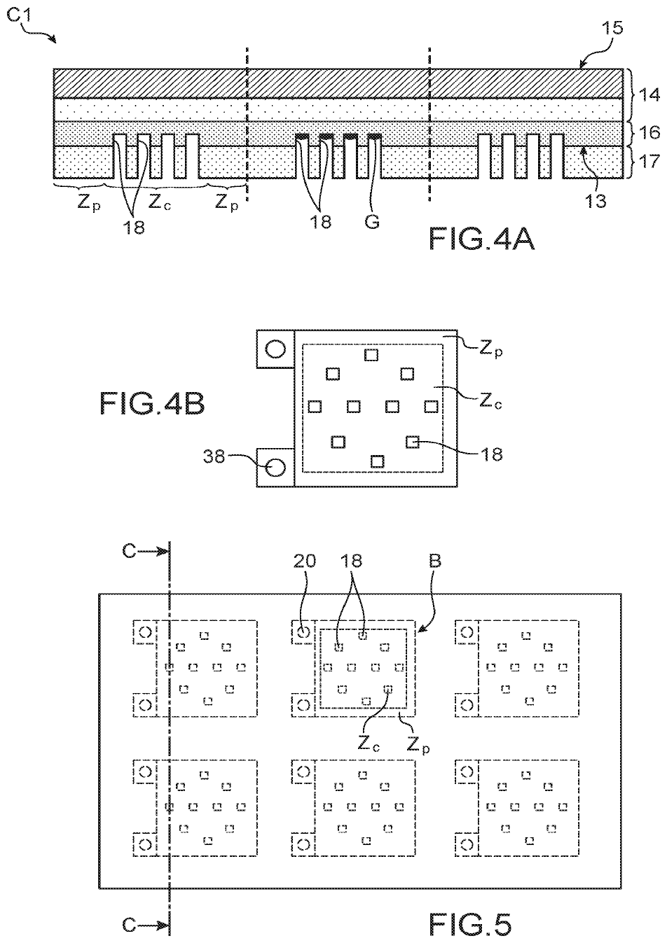

FIGS. 3, 4A and 4B show an example of a set of covers C1 during manufacture and ready to achieve encapsulation according to the invention. On FIG. 4A, the covers are symbolically separated by dashed lines.

Cover C1 comprises a first face 13 that will be in contact with the stack of a microbattery and the support substrate 2, and a second face 15 that will be in contact with the external environment. The first face 13 comprises a central zone Zc that will be in contact with the microbattery stack, and a peripheral zone Zp surrounding the central zone and that will be in contact with the support substrate 2 and surround the microbattery. FIG. 4B shows a bottom view of the cover in FIG. 4A.

Cover C1 comprises a stack comprising a barrier film 14 and a layer 16 designed to secure the cover C1 on the support substrate 2 and on the microbattery and to form sealed encapsulation of the microbattery. For example, the layer 16 is a bonding layer comprising a material adapted to bond to the support substrate, to the microbattery and to the barrier film. The layer 16 will be designated “adhesive layer” or “securing layer” in the remainder of the description.

The face of the barrier film 14 that is not in contact with the adhesive layer 16 forms the second face 15 of the cover, and the face of the adhesive 16 that is not in contact with the barrier film 14 forms the first face 13 of the cover.

The barrier film 14 is designed to make the encapsulation cover leak tight relative to the external environment, particularly regarding oxidising species such as water vapour, oxygen, nitrogen, hydrogen, etc. The thickness of the barrier film 14 may for example be between a few μm and a few hundred μm.

The barrier film 14 comprises for example a foil composed of a homogeneous single-layer material or a heterogeneous multi-layer material. Advantageously, it is chosen from among the family of materials that form a strong barrier to oxidising elements present in the atmosphere. For example, it is a metal foil, for example less than 300 μm thick, based on aluminium or based on steel, such as tin plate, black plate, chrome iron, stainless steel, etc.

As a variant, it comprises a stack of layers of different natures, for example organic and inorganic, chosen to improve its leak tightness with regard to oxidising species.

In the example in FIGS. 3 and 4A and 4B, the barrier film 14 comprises foil 14.1 and a film 14.2 designed to reinforce the mechanical strength of the cover. For example, the reinforcing film 14.1 may be made of a thermoplastic material, for example less than 100 μm thick. The thermoplastic material can be chosen from among polyethylene naphthalate (PEN), polypropylene (PP), polyethylene terephthalate (PET), polyimide (PI), etc.

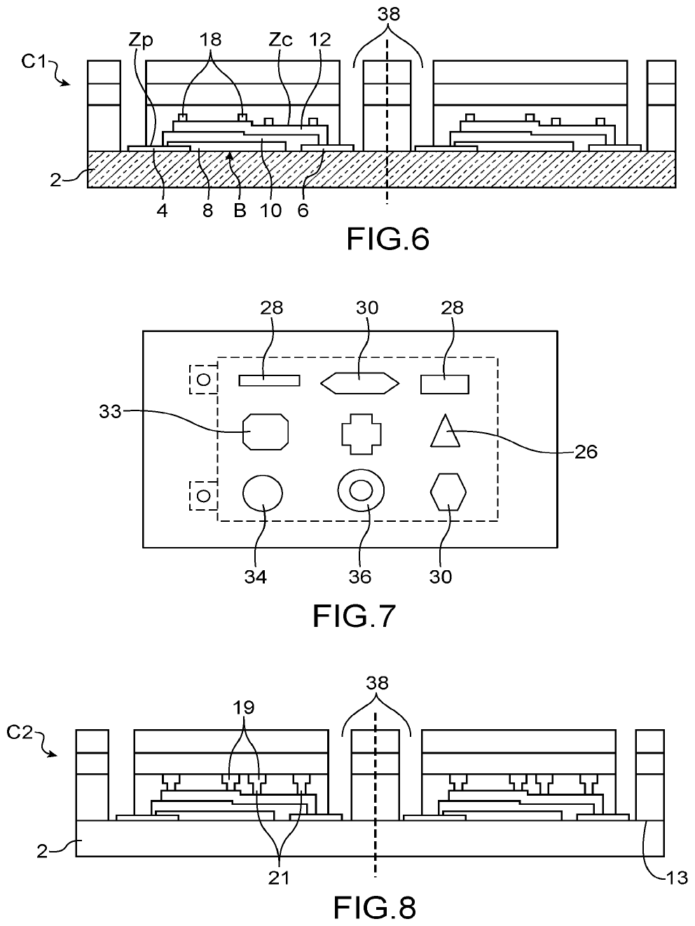

The thickness of the adhesive part 16 is chosen such that it confers on the encapsulation layer some aptitude to match the profile of the stack as can be seen on FIG. 6. This aptitude to match the relief of the microbattery can guarantee efficient protection of the active layers of the microbattery. Preferably the thickness of the adhesive layer is at least equal to the height of the microbattery, for example it may be between a few μm and a few tens of μm thick.

The material of the adhesive layer 16 is chosen so as to have bonding, electrical insulation properties and to be chemically compatible with the active layers of the microbattery. The adhesive layer 16 may for example be made from polymer films based on acrylic, silicone, rubber or a mixture of these materials. For example, Tesa®, Henkel® or 3M® insulating adhesives can be suitable.

The material of the adhesive layer can be activated for example by pressure and/or temperature and/or ultraviolet rays, etc.

For example, the barrier film 14 is a complex formed from a 35 μm thick aluminium layer and a 28 μm thick PET layer. The adhesive layer 16 is a 25 μm thick polymer, for example complexes of Tesa61570° together with adhesives with a total thickness of 78 μm marketed by the Tesa company.

The adhesive layer 16 is preferably protected by a protection film 17 that can be removed at the time of assembly with the microbatteries, for example PET with a thickness of a few μm, for example 150 μm.

In one example embodiment, the cover has elastic properties so that it can deform elastically under pressure of the gas generated during operation of the battery. This deformation of the cover is determined so as to not provoke separation at the peripheral zone to prevent all risk of loss of leak tightness.

The encapsulation cover comprises cavities 18 opening up in the first face 13 that will be in contact with the microbattery.

In the example shown on FIG. 4A, only the adhesive layer 16 comprises cavities 18, the cavities not opening up in the barrier film.

On FIG. 4A, the cavities 18 pass through the protection film 17. Preferably, the cavities are made with the protection film 17 in place. Keeping the protection film 17 allows to protect the adhesive first face of the cover from contaminants, especially from water.

When the cover is put into place, the protection film 17 is removed as can be seen on FIG. 6, with portions of cavities formed in the protection film. The total storage volume of the cavities 18 is greater than the volume of gas that the microbattery can potentially generate throughout its entire life. Advantageously, the total storage volume of the cavities is equal to at least twice the volume of gas that will potentially be generated, or even at least 5 times more. Thus, the risk of swelling at the bond interface between the microbattery and the cover is significantly reduced or even eliminated.

The encapsulation cover in FIG. 4A is particularly advantageous, when the barrier film is electrically conducting. During application of the cover on the microbattery, the adhesive layer is deformed to match the relief of the battery. The result is deformation of the cavities. Making cavities only in the adhesive layer without them opening up in or on the barrier film eliminates all risk of a short circuit between elements of the microbattery, particularly between the negative electrode and the barrier film. Nevertheless, by providing a sufficiently thick adhesive layer, the cavities can open up in the barrier film while preventing contact between the barrier film and the microbattery.

According to another example embodiment, the barrier film comprises foil and a reinforcing layer made of an electrically insulating material, the cavities can open up in the reinforcing layer. According to another example, the barrier film comprises only one or more electrically insulating materials, the cavities can open up in all layers of the barrier film.

In one advantageous embodiment, it can be planned for all cavities or for some cavities to comprise one or several materials capable of absorbing or capturing gases generated by the microbattery, they may be getter materials G (FIG. 4A) and the gases are not only stored in the cavities, they are trapped. The absorbent material(s) is (are) deposited on the cavity walls after the cavities have been formed and/or they are integrated into the material of the adhesive layer forming particulate inclusions in the cavity walls. These absorbent materials may be deposited in thin layers, for example a few μm thick.

When such materials are used in the cavities, the total planned volume for storing gas may be less than the volume potentially generated throughout the life of the battery.

For example, the absorbent materials are chosen from among materials in column IVB in the periodic table, such as titanium, zirconium, hafnium, or vanadium, nickel, iron, aluminium or cobalt. The getter material may be formed from among calcium layers or lithium layers.

The cavities 18 are distributed in the first face 13 so as to open up in the central zone Zc that will be in contact with the microbattery and as close as possible to generation of the gas.

The peripheral zone Zp makes it possible to guard against lateral infiltration of oxidants through the polymers in the adhesive part. Preferably, the cavities are formed relatively far from the peripheral zone Zp to limit any lateral infiltrations of oxidants. For example, in the case of an adhesive polymer, not containing an absorber, with a thickness of 25 μm, the width of the peripheral zone is preferably at least 0.5 mm.

FIG. 8 shows another example of an encapsulation cover C2 according to the invention comprising storage volumes, each comprising a cavity 19 and a channel 21 connecting the cavity 19 to the first face 13 of the cover that will be in contact with the microbattery. The cavities 19 are offset below the first face 13. The channels 21 have a smaller cross-section than the cavities, the surface area of the first face not participating in bonding on the microbattery is reduced. The total storage volume of the cavities 19 is determined to enable storage of the entire potentially generated volume of gas.

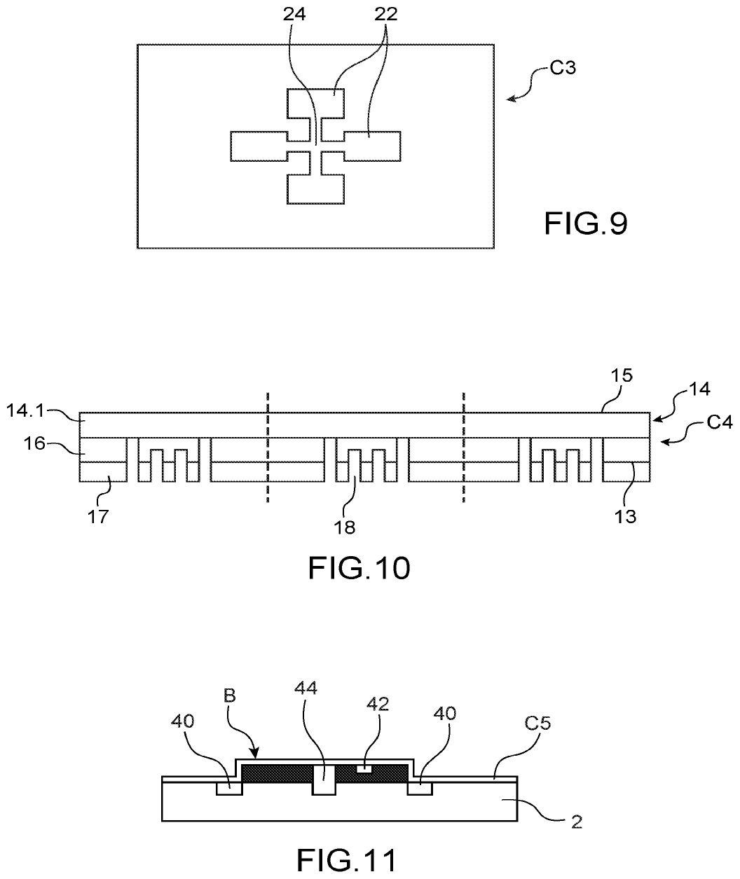

FIG. 9 shows another example of an encapsulation cover C3 according to the invention. In this example, the cover comprises several cavities 22 and a channel 24 connecting the cavities 22 to the first face 13 of the cover facing the microbattery. Thus, the gas(es) generated during operation of the microbattery is (are) guided towards the cavities through a single channel 24. The proportion of the first face that does not participate in bonding is also reduced, therefore the bonding properties of the encapsulation cover are similar to the bonding properties of a cover according to the state of the art, i.e. without cavities.

It should be noted that the anode layers are intrinsically porous and the gas flow follows preferred paths through the pores to reach the microcavities. Consequently, the reduction of “collection zones” is not prejudicial to the uniform collection of gases.

As a variant, the cover comprises at least one cavity and several channels opening up in said cavity.

The volumes of the different cavities may be different from each other.

The examples in FIGS. 8 and 9 are preferably made by structuring the adhesive layer before it is assembled with the barrier film. To achieve this, the cavities are formed in the adhesive layer starting from its face that will be in contact with the barrier film, and then the channel(s) is (are) formed.

Covers C2 and C3 in FIGS. 8 and 9 are particularly well adapted to the examples in which the cavities are formed entirely or partly in the electrically conducting barrier film. Due to the smaller cross-section channels and despite deformation of the cover during the encapsulation step, the risks of a short circuit between the barrier film and the microbattery are very much reduced or even eliminated.

The surface area occupied by the cavities and/or the channels leading to the cavities accounts for not more than 80% of the total surface area of the adhesive film 16 fixed to the component, guaranteeing sufficient lateral protection for integrity of the component. Advantageously, the surface area occupied by the cavities and/or the channels leading to the cavities represents not more than 25% of the total surface area of the adhesive film, and preferably not more than 10% of the total surface area of the adhesive film.

Preferably, the width of the peripheral zone is determined as a function of the nature and the thickness of the adhesive film 16. The width of the peripheral zone increases with the reduction in thickness of the adhesive film 16.

The shape of the cavities, and particularly their section opening up in the first face, can be any shape. On FIG. 5, the shape of the section is square. FIG. 7 shows a cover with cavities with a variety of shapes, such as triangular 26, rectangular 28, hexagonal 30, cross 32, square with bevelled corners. The shapes can be more or less narrow. As a variant, the section of the cavities may be circular 34 or annular 36. It will be understood that a cover preferably comprises cavities of the same shape to simplify fabrication, but that a cover with different shapes of covers is not outside the scope of the invention.

In one advantageous example, openings 38 passing through the entire thickness of the cover are formed at the locations of the electrical contacts 4 and 6. These openings 38 enable an escape of air between the cover and the microbattery and reduce the risk of having bubbles trapped between the cover and the microbattery. They also enable access to contacts 4, 6 in order to make contacts. They are also advantageously used to align the cover relative to the microbattery(ies) during the encapsulation step.

FIG. 10 shows an example embodiment of the encapsulation cover C4, in which the barrier film does not comprise a reinforcing film, therefore the thickness of the cover is reduced. Furthermore in this example, the depths of the cavities are different and some open up on the barrier film and others remain only in the adhesive layer 16

Operation of an encapsulated battery according to the invention will now be described.

When the microbattery is being charged, i.e. when it outputs electricity, gaseous elements are generated at the positive electrode 8, that is formed on the support substrate 2. Gaseous elements migrate through the electrolyte 10 and the negative electrode 12 and come into contact with the encapsulation cover C1, as symbolised by the arrows G. The gaseous elements flow in the cavities 18 opening up in the first face 13 of the cover, either directly, or through one or several channels.

During the encapsulation step, the encapsulation cover is deformed, in particular the adhesive layer 16 that is made of a deformable material, also causing deformation of the cavities 18. Under the pressure applied by the gaseous elements, the cavities swell to at least return to their shape before the encapsulation step.

An example of a method of making an encapsulated battery according to the invention will now be described.

The method of making an encapsulated microbattery according to the invention may for example comprise the following steps:
make a microbattery on a support substrate,
make a cover leak tight to oxidising species comprising an adhesive layer that will come into contact with the microbattery and the substrate,
formation of cavities or cavities and channels, in fluid communication with the face of the cover that will come into contact with the microbattery and the substrate,
alignment and positioning of the encapsulation cover above the microbattery and the substrate,
transfer said cover on the substrate and the microbattery for example by applying a pressure force.

The microbattery in FIG. 2 is made during a first step. The method of making such a microbattery is well known to a skilled man.

For example, starting from a support substrate that is made for example from glass or silicon on which electrical contacts have been formed, for example by depositing and structuring a metal layer, the positive electrode is made, for example from LiCoO₂ for example chemically, for example by chemical vapour deposition or physical vapour deposition (PVD). For example, an LiCoO₂ layer is formed on the substrate and electrical contacts by sputtering from an LiCoO₂ target to form a layer with a thickness, for example, equal to 10 μm. The positive electrode may for example be delimited by a mechanical mask, by photolithography, by laser etching, etc.

A heat treatment can then advantageously be made, for example at 600° C. for 2 h, so that a crystalline phase appears in the LiCoO₂ layer.

During the next step, the electrolyte is formed on the positive electrode, for example LiPON, LiPONB or LiSiCON can be used. For example, a LiPON electrolyte is 2 μm thick. It may be formed by cathodic sputtering from a target previously prepared by sintering an Li₃PO₄ powder. The LiPON layer is made by adding a reactive nitrogen gas during the deposition. The nitrogen concentration is tested depending on deposition conditions such as the temperature, power, pressure.

During a subsequent step, a layer is formed on the electrolyte to make the negative electrode, for example from a layer of lithium or lithiated material. For example, the layer of metallic lithium is 2 μm thick and is obtained by evaporation under a vacuum.

The stack in FIG. 2 is thus obtained.

For example, immediately after making the active layers, the microbattery has a potential difference oscillating between 1V and 2V in the case in which the anode used is made of a lithium material. Deinsertion of lithium from the cathodic layer corresponds a charge cycle of the microbattery. This is generally manifested by an increase in the potential difference between the cathode and the anode under the effect of a charge current up to a voltage of the order of 4.2V in the case of an LiCoO2 cathode and a lithium metal anode. The charge movement is accompanied by abundant gas production synchronous with the charge state of the battery. Thus, this degassing phenomenon reaches its peak at a full charge state at 4.2V corresponding to complete deinsertion of lithium from the cathode.

The majority gas generated by an LiCoO₂ type electrode is oxygen or compounds of oxygen (CO, CO₂). For example, a 10 μm thick positive electrode made of LiCoO₂ with a real surface area of 4 cm² obtained with the operating conditions described above can generate a relative partial pressure that can be as high as 0.1 bars after a single charge cycle and up to 1 bar after about 10 charge cycles. The total volume that can be generated by this degassing phenomenon is 1 mm³. Therefore the cavities of the encapsulation cover are advantageously configured to store at least 1 mm³+/−10%.

The encapsulation cover is made during another step. For example, it may comprise a metal foil and a PET layer forming the barrier film and an adhesive layer. According to one embodiment, the cover is obtained using a rolling process of a 28 μm thick PET film on a 35 μm thick aluminium barrier film done under a vacuum at ambient temperature. The surface area of the encapsulation cover corresponds approximately to the surface area of the microbattery to be encapsulated comprising the central zone and the peripheral zone.

To make the cover C1 in FIG. 4, the cavities are for example made from the first face of the cover by local etching using a laser. The wavelength of the laser is chosen as a function of the material of the adhesive layer and/or the barrier film and the dimensions of the cavities. For example, a CO₂ laser (10.4 μm wavelength) having a frequency of 1 ms and a power of 3 Watts and a displacement speed of 10 mm/s is easily capable of excavating rectangular shapes (0.5 mm×0.5 mm) with a depth of 0.02 mm.

The dimensions of the cavities are advantageously between:
0.5 mm+/−100 μm×0.5 mm+/−100 μm for the bottom of the cavity,
0.02 mm+/−100 μm for the depth.

As a variant, the cavities can be made by mechanical removal, such as punching, or by chemical etching.

Preferably, the cavity formation step is done in the presence of the protection film so as to protect the integrity of the bonding face.

According to this example, the laminated films are structured before removing the protection films. The manufacturing of the cavity described above allows not to damage the protection fil, i.e. allows to avoid degradation/transformation of film 17, which could provoke either a permanent bonding of protection film 17 to film 16, or a bad delimitation of cavities 18. Indeed the protection film and the securing fil 16 are commonly of the same nature and the selective etching by the laser is difficult to control.

To make the covers in FIGS. 8 and 9, the adhesive layer is structured before its assembly with the barrier film from the back face of the adhesive layer, the cavities being formed first followed by the channels. In the examples, the cavities are formed in the adhesive layer, the barrier film forming or not forming one of the walls of cavities. As a variant, the cavities are entirely or partly formed in the barrier film.

As a variant, the cavities are formed using a laser.

The cavities are made in the central zone Zc of the cover. The openings 38 for the contacts can also be formed during the step to make the cavities. The laser is programmed to make cavities at given locations that may or may not be at a given pitch. Preferably, the cavities are uniformly distributed.

During a next step, the structured cover is transferred onto the microbattery. This is done by aligning the cover with the microbattery such that the cavities 18 are facing the stack. Preferably, the openings 38 for contacts 4, 6 are used for the alignment. The first face 13 of the cover in which the cavities open up is brought close to the microbattery.

The second face 15 of the cover is then pressed towards the microbattery and the substrate so as to bring the adhesive layer 16, the microbattery and the substrate into intimate contact. For example, encapsulation is made by rolling or sealing.

In the example assembly by rolling, assembly is preferably made under a vacuum or under a controlled atmosphere, so as to guard against oxidation of the lithiated layers. Rolling conditions can be adjusted as a function of the nature of the adhesive films used. Preferably, the assembly between the encapsulation cover, for example comprising an aluminium layer, a PET layer and an adhesive layer and the microbattery, is made at a temperature of the order of 90° C. with a pressure of more than 1 bar and at a speed of less than 3 m/mn. The adhesive layer may for example comprise the material reference Tesa61562 with a thickness of 25 μm marketed by the Tesa company.

Depending on the type of material used for the adhesive layer, it is possible that heating may not be necessary during rolling, for example using an adhesive layer with a material cross-linked by UV insolation, after rolling. In this case, the barrier film is chosen to be transparent to UV rays. Examples of adhesives that can be used are those manufactured by Tesa with references Tesa61560, Tesa61501, Tesa61562, those manufactured by 3M with references 1007N, 9703, those manufactured by Henkel with references Ablefilm ECF550, Ablefilm ECF561E, etc. The transparent barrier films can be made using the material reference Tesa61560 marketed by Tesa, GL film marketed by Toppan, or FTB3-50 and FTB3-125 marketed by 3M.

In one variant, the cover is assembled on the microbattery by sealing. This is done by applying a uniformly distributed pressure over the entire second face of the cover, towards the substrate and the microbattery, advantageously in the presence of a heating system. The sealing pressure may be of the order of 2 bars and the temperature of the order of 90° C. in the case of a Tesa60260, Tesa61562 adhesive layer and an aluminium/PET barrier layer, so as to guarantee an excellent bond between the cover and the substrate supporting the microbattery.

The encapsulated barrier represented on FIG. 6 is then formed. The cover is shaped to match the relief of the microbattery and is in intimate contact with it.

In the examples shown, several batteries are encapsulated simultaneously. A layer of several encapsulation covers is then made, each comprises a central zone and a peripheral zone, that are simultaneously aligned with the microbatteries formed on a single support substrate. Encapsulation is then done as described above, by rolling or by sealing. The encapsulated microbatteries are then separated from each other, for example by sawing.

In another embodiment, a temporary protection layer is formed on the lithiated layers, so that the cover transfer step can be carried out without the need for an inert atmosphere. The protection layer is formed just after formation of the anode layer. The protection layer may for example by made of alumina, for example deposited by an Atomic Layer Deposition (ALD) process. For example, the thickness of the protection layer is between 10 nm and 50 nm and the optimum temperature of the ALD process is of the order of 80° C.

In another embodiment represented on FIG. 11, cavities 20 are formed in the substrate 2 only, cavities 22 are formed in the microbattery stack only and cavities 24 are formed both in the microbattery stack and in the substrate.

The microbattery may comprise cavities 40 and/or cavities 42 and/or cavities 44.

In this example, the cover C5 does not comprise any cavities 18. In another example, the microbattery comprises cavities 18 in the cover and cavities 40 and/or 42 and/or 44. The volume of all the cavities is fixed so as to contain all the potentially generated gas.

The manufacturing method for such an encapsulated microbattery is similar to that described above. The cavities 40, 42, 44 can be made by etching after the substrate and microbattery assembly has been made and before the cover is put into place. The cavities in the cover are made as described above.

1. Encapsulated microbattery comprising a microbattery supported on a substrate, an encapsulation cover, said encapsulation cover comprising a first face in contact with the microbattery and the substrate, said first face comprising a central zone and a peripheral zone surrounding the central zone, the central zone being in contact with the microbattery and the peripheral zone being in contact with at least the substrate,
the encapsulated microbattery comprising at least one cavity configured to collect a gaseous element generated by the microbattery, said at least one cavity being formed:
in the encapsulation cover in fluid communication with the central zone, and/or
in the substrate, and/or
in the microbattery.

2. Encapsulated microbattery according to claim 1, in which the cover comprises a barrier film and a securing layer supporting the first face and in which said at least one cavity is formed only in the securing layer.

3. Encapsulated microbattery according to claim 1, in which the cover comprises at least one channel connecting said at least one cavity to the first face.

4. Encapsulated microbattery according to claim 3, in which the cover comprises at least one group of several cavities connected to the first face through a common channel.

5. Encapsulated microbattery according to claim 1, in which the barrier film comprises metal foil and a reinforcing layer, said reinforcing layer being in contact with the securing layer (16).

6. Encapsulated microbattery according to claim 1, comprising at least one absorbent material configured to absorb at least one of the gaseous elements that can be generated by the microbattery.

7. Encapsulated microbattery according to claim 6, in which the absorbent material is integrated in the adhesive layer and/or is deposited in said cavity.

8. Encapsulated microbattery according to claim 1, in which said at least one cavity (18) comprises ae storage volume which is at least equal to twice the total volume of gaseous elements that said microbattery can generate.

9. Encapsulated microbattery according to claim 1, in which the peripheral zone has a width which is equal to at least 0.5 mm.

10. Encapsulated microbattery according to claim 1, in which the securing layer is made of a deformable polymer material sufficiently thick to match the relief of the microbattery relative to the support substrate.

11. Encapsulated microbattery according to claim 1, in which the microbattery comprises a positive electrode made of LₓM_{y}O_{z}, M being a transition metal, formed on the support substrate and a negative electrode made of lithium or a lithiated material.

12. Encapsulated microbattery according to claim 11, in which the cover comprises an opening passing through the cover in the direction of its thickness and opening up on an electrical contact connected to the positive electrode and an opening passing through the cover and opening up on an electrical contact connected to the negative electrode

13. Method of manufacturing at least one encapsulated microbattery comprising:
supply of a microbattery made on a substrate,
manufacturing of an encapsulation cover comprising a first face provided with a securing layer capable of securing said cover to said microbattery and to said substrate,
the cover comprising at least one cavity capable of collecting a gaseous element generated by the microbattery, said at least one cavity being formed:
in the encapsulation cover in fluid communication with the central zone, and/or
in the substrate, and/or
in the microbattery,
placement of the cover on the microbattery and on the substrate, such that the first face is in contact with the microbattery and the substrate, and in the case in which the cover comprises a cavity, such that said at least one cavity opens up facing said microbattery,
securing said cover to said microbattery and to said substrate so as to form an encapsulation of said microbattery.

14. Manufacturing method according to claim 13, in which the at least one cavity is made by structuring of the securing layer.

15. Manufacturing method according to claim 13, in which the at least one cavity is made from the first face of the cover.

16. Manufacturing method according to claim 13, in which a protection film covers said first face of the cover during formation of the at least one cavity in the cover and removal of the protection film.

17. Manufacturing method according to claim 13, in which the at least one cavity is formed in the securing layer before its attachment to a barrier film.

18. Manufacturing method according to claim 13, in which the securing of the cover on the microbattery comprises a rolling step.

19. Manufacturing method according to claim 13, in which securing comprises a step to apply a uniform pressure simultaneously over the entire surface area of the cover towards the substrate.

20. Manufacturing method according to claim 18, comprising a heating step during the securing.

21. Manufacturing method according to claim 13, comprising making the microbattery on the substrate, said microbattery comprising a positive electrode made of LₓM_{y}O_{z}, M being a transition metal, formed in contact with the support substrate, an electrolyte and a negative electrode made of lithium or a lithiated material.
